(19) United States
(12) Patent Application Publication
(10) Pub. No.: US 2008/0090106 A1
(43) Pub. Date: Apr. 17, 2008

(54) Soft underlayer for perpendicular media with mechanical stability and corrosion resistance

(76) Inventors: David Braunstein, Campbell, CA (US); Qing Dai, San Jose, CA (US); Yoshihiro Ikeda, San Jose, CA (US); Ernesto Marinero, Saratoga, CA (US); Run-Han Wang, San Jose, CA (US)

Correspondence Address: HITACHI GLOBAL STORAGE TECHNOLOGIES, INC., 5600 COTTLE ROAD, NHGB/0142, IP DEPARTMENT, SAN JOSE, CA, 95193, US

(21) Appl. No.: 11/580,648

(22) Filed: Oct. 13, 2006

(51) Int. Cl. G11B 5/66

(52) U.S. Cl. 428/829

(57) ABSTRACT

A perpendicular magnetic recording disk has a granular cobalt alloy recording layer (RL) containing on the “soft” magnetic underlayer (SUL). The SUL is doped with judiciously chosen elements or alloys or is capped or intercalated with said elements or metal alloy layers. The resulting disk and the SUL in particular has good recording properties, improved mechanical strength and improved corrosion resistance over a comparable disk without the doping or thin layers.

### BACKGROUND OF THE INVENTION

1. Field of the Invention

This invention relates generally to perpendicular magnetic recording media, and more particularly to a disk with a perpendicular magnetic recording layer for use in magnetic recording hard disk drives.

2. Description of the Related Art

Perpendicular magnetic recording, wherein the recorded bits are stored in a magnetic layer having perpendicular or out-of-plane orientation of the magnetic axis, is a promising path toward ultra-high recording densities in magnetic recording hard disk drives. A common type of perpendicular magnetic recording system is one that uses a “dual-layer” media. This type of system is shown in FIG. 1 with a single write pole type of recording head. The dual-layer media includes a perpendicular magnetic data recording layer (RL) formed on a “soft” or relatively low-coercivity magnetically permeable underlayer (SUL). The SUL serves as a flux return path for the field from the write pole to the return pole of the recording head. In FIG. 1, the RL is illustrated with perpendicularly recorded or magnetized regions, with adjacent regions having opposite magnetization directions, as represented by the arrows. The magnetic transitions between adjacent oppositely-directed magnetized regions are detectable by the read element or head as the recorded bits.

FIG. 2 is a schematic of a cross-section of a prior art perpendicular magnetic recording disk showing the write field H_{w} acting on the recording layer RL. The disk also includes the hard disk substrate, a seed or onset layer (OL) for growth of the SUL, an intermediate layer (IL) between the SUL and the RL, and a protective overcoat (OC). The IL is a nonmagnetic layer or multilayer structure, also called an “exchange break layer” or EBL, that breaks the magnetic exchange coupling between the magnetically permeable films of the SUL and the RL and facilitates epitaxial growth of the RL with its basal plane parallel to the thin film plane. While not shown in FIG. 2, a seed layer is typically deposited directly on the SUL to facilitate the desired growth orientation of the IL. As shown in FIG. 2, the RL is located inside the gap of the “apparent” recording head (ARH), which allows for significantly higher write fields compared to longitudinal or in-plane recording. The ARH comprises the write pole (FIG. 1) which is the real write head (RWH) above the disk, and an effective secondary write pole (SWP) beneath the RL. The SWP is facilitated by the SUL, which is decoupled from the RL by the IL and by virtue of its high permeability produces a magnetic mirror image of the RWH during the write process. This effectively brings the RL into the gap of the ARH and allows for a large write field H_{w} inside the RL.

The soft underlayer (SUL) is an integral part of the perpendicular recording media (PRM) structure, it provides field closure to the recording head, thereby permitting the magnetic switching of higher coercivity media than employed in longitudinal recording. For optimum media performance, the SUL is magnetically soft, exhibits single domain characteristics, exhibits uniaxial anisotropy and has its magnetic axis preferentially aligned along the radial direction.

Amorphous, high permeability materials satisfy these magnetic specifications and are currently employed in perpendicular media fabrication. An inherent problem with current-art amorphous SUL materials is their relative mechanical softness when compared to crystalline layers. This renders PRM more susceptible to damage and scratching during post-sputter processing or at the file level through accidental head-disk interactions. Although thicker and harder overcoats can improve the mechanical robustness of the recording medium, a thicker overcoat increases the magnetic spacing with deleterious consequences to the media recording performance. What is needed is an approach to improve the intrinsic mechanical properties of the SUL to increase the robustness of PRM. This is the subject of the current invention.

Another problem with current-art amorphous SUL materials is their high corrosion propensity that hinders the chemical stability of perpendicular recording media. The problem is exacerbated by the rough microstructure of the intermediate layer(s) grown upon the SUL. The roughness is used to control the segregation of the recording layer. Current-art solutions include usage of dual intermediate layers, including sputtering Ru at different pressures, whereby a dense thick overlayer is deposited on the SUL. The thick overlayer deposited on the SUL is followed by rougher underlayer component. Although this solution improves the overall corrosion characteristics of the PRM stack, defects or voids present in the thick overlayer could compromise the chemical stability of PRM. What is also needed is an approach to improve the intrinsic corrosion characteristics of the SUL itself without a thick overlayer.

### SUMMARY OF THE INVENTION

The invention is a perpendicular magnetic recording disk with a recording layer (RL), an exchange-break layer on the soft underlayer (SUL). The SUL is doped with a judiciously chosen material in order to increase the mechanical hardness of the SUL.

Further, elements like niobium incorporated in spacer/capping layers or in the SUL itself increases the corrosion resistance of the SUL. Thus, thick overlayers are not required for preventing corrosion.

For a fuller understanding of the nature and advantages of the present invention, reference should be made to the following detailed description taken together with the accompanying figures.

### BRIEF DESCRIPTION OF THE DRAWINGS

FIG. 1 is a schematic of a prior art perpendicular magnetic recording system.

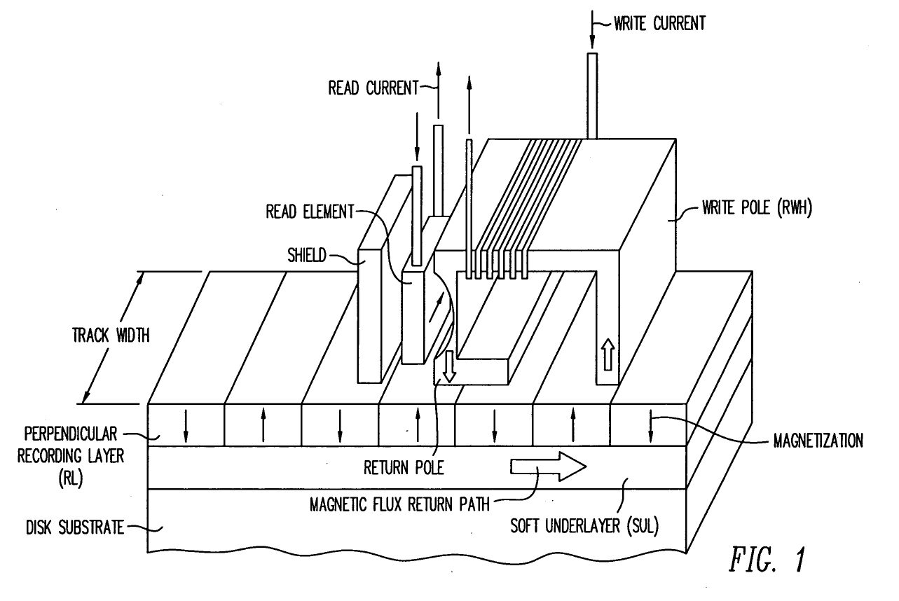

FIG. 2 is a schematic of a cross-section of a perpendicular magnetic recording disk according to the prior art and depicting the write field.

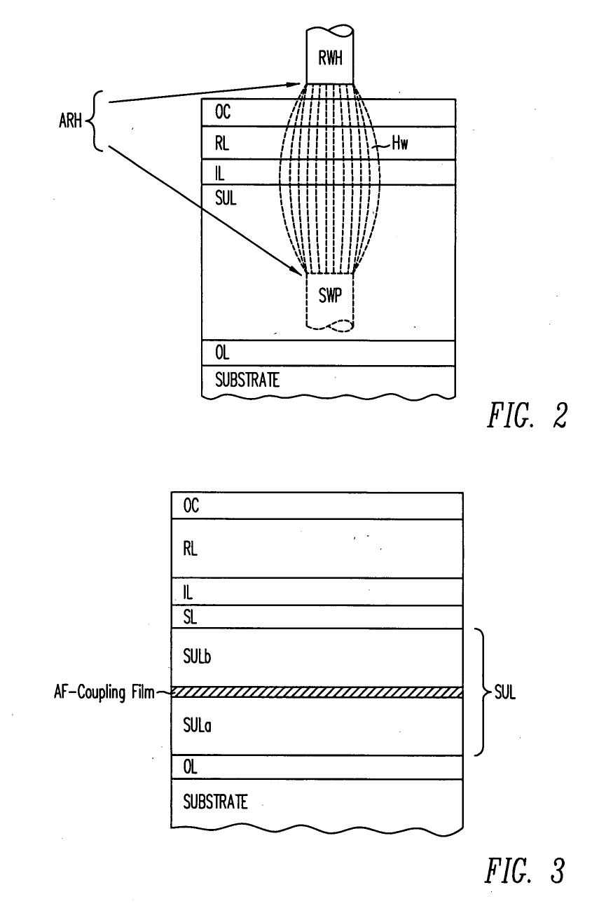

FIG. 3 is a schematic of a cross-section of a perpendicular magnetic recording disk.

FIG. 4 is a graph showing the effect of dopants on magnetic properties of an SUL.

FIG. 5 is a graph showing the effect of SUL doping on mechanical hardness.

FIG. 6 is a graph showing dopant effect on radial magnetic anisotropy of CoTaZr soft underlayers.

FIG. 7a is a graph of scratch depth of disks with different cap thicknesses.

FIG. 7b is a chart of scratch probabilities on disks with and without caps.

FIGS. 8a and 8b compare the effect on corrosion characteristics by increasing doping amounts of Cr and Nb into a CoTaZr soft underlayer.

FIG. 9 shows the effect of doping a CoTaZr soft underlayer with Cr, Nb, Pt and Re at a 10% level.

FIG. 10 is a graph of open circuit potentials versus dopant concentration in CoTaZr SULs.

FIG. 11 is a graph of the effect of Nb doping into CoTaZr SULs on coercivity and uniaxial anisotropy.

FIGS. 12(a) and (b) are soft underlayer structures for improving corrosion characteristics of perpendicular recoding media.

FIGS. 13(a) and (b) are additional soft underlayer structures for improving corrosion characteristics of perpendicular recording media.

FIG. 14 is a graph comparing corrosion characteristics of SUL layers comprising 2 nm thick spacer layers of Cr, Nb, Pt and Re.

FIG. 15 is a graph of open circuit potential measurements for SUL structures capped with various 2 nm thick layers of various transition metals and binary alloys.

FIG. 16 is a graph where easy axis coercivity and uniaxial anisotropy are compared between SULs employing nanolayers and those measured in identical layers employing either single or dual layer deposition.

### DETAILED DESCRIPTION OF THE INVENTION

An “X-alloy” means an alloy of only X or an alloy including X (e.g. the term CoFe alloy includes CoFe as well as CoFeO and CoFeC). An alloy includes at least two elements and does not need to include a metal.

“Above” means on but not necessarily directly on.

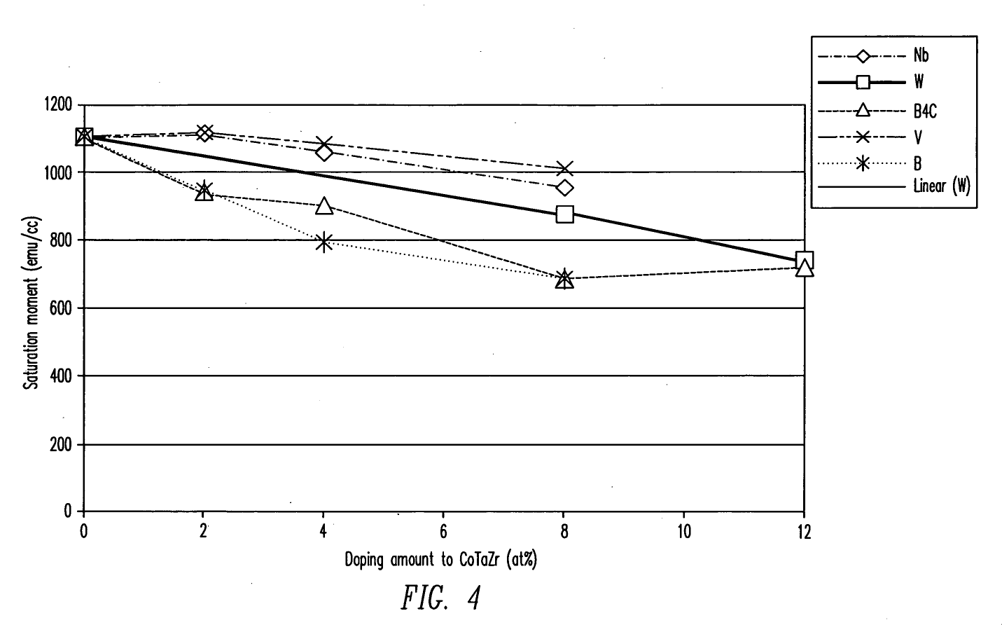

FIG. 3 is a schematic of a cross-section of a perpendicular magnetic recording disk according to the prior art and illustrating an antiferromagnetically-coupled SUL. The various layers making up the disk are located on the hard disk substrate. The substrate may be any commercially available glass substrate, but may also be a conventional aluminum alloy with a NiP or other known surface coating, or an alternative substrate, such as silicon, canasite or silicon-carbide. The SUL is located on the substrate, either directly on the substrate or directly on an adhesion layer or OL. The OL facilitates the growth of the SUL and may be an AlTi alloy or a similar material with a thickness of about 2-5 nanometers (nm). In the disk of FIG. 3, the SUL is a laminated or multilayered SUL formed of multiple soft magnetic layers (SULa and SULb) separated by an interlayer film (such as Ru, Ir, or Cr) that acts as an antiferromagnetic (AF) coupling interlayer film to mediate antiferromagnetic exchange coupling between SULa and SULb. This type of SUL is described in U.S. Pat. Nos. 6,686,070 B1 and 6,835,475 B2. However, instead of the AF-coupled SUL, the SUL may be a single-layer SUL or a non-AF-coupled laminated or multilayered SUL that is formed of multiple soft magnetic films separated by nonmagnetic films, such as films of carbon or SiN or electrically conductive films of Al or CoCr. The SUL layer or layers are formed of amorphous magnetically permeable materials such as alloys of CoNiFe, FeCoB, CoCuFe, NiFe, FeAlSi, FeTaN, FeN, FeTaC, CoTaZr, CoFeB, and CoZrNb or quaternary alloys such as CoFeTaZr. The thickness of the SUL is typically in the range of approximately 50-400 nm. The OC formed on the RL may be an amorphous “diamond-like” carbon film or another known protective overcoat, such as silicon nitride (SiN).

The nonmagnetic IL on the SUL is a nonmagnetic metal or alloy having a hexagonal close-packed (hcp) crystal structure for controlling the hcp crystal orientation in the granular RL. The IL promotes the growth of the hcp granular RL so that its c-axis is oriented substantially perpendicular, thereby resulting in perpendicular magnetic anisotropy. Ruthenium (Ru) is a commonly used material for the IL, but other materials include a metal selected from Ti, Re, and Os, and an alloy containing at least one element selected from Ti, Re, Ru, and Os, including Ru-based alloys such as a RuCr alloy. The IL may be formed on a seed layer (SL) formed on the SUL.

The RL is a granular ferromagnetic Co alloy with intergranular material that includes an oxide or oxides. The oxides are typically oxides of one or more of Si, Ta, Ti and Nb. The RL may also contain Cr, with one or more oxides of Cr also being present as intergranular material.

Amorphous Alloys in the SUL

The SUL is strengthened with the addition of high melting point elements and alloys. To illustrate the advantages of the addition of these dopants, 60 nm thick CoTaZr soft underlayers were deposited on AlTi-coated textured glass substrates. The SUL was overcoated in turn with 2.5 nm of SiN. Improvements to the SUL hardness were sought by increasing the glass transition temperature T_{g}, of the amorphous alloy through doping with high melting point (Tₘ) refractory elements and alloys. To a first order, T_{g}≈2Tₘ/3 (Wang et al, J. Mat. Res., 18, 2747, 2003). Further, high melting point materials are utilized to increment the glass transition temperature of amorphous alloys.

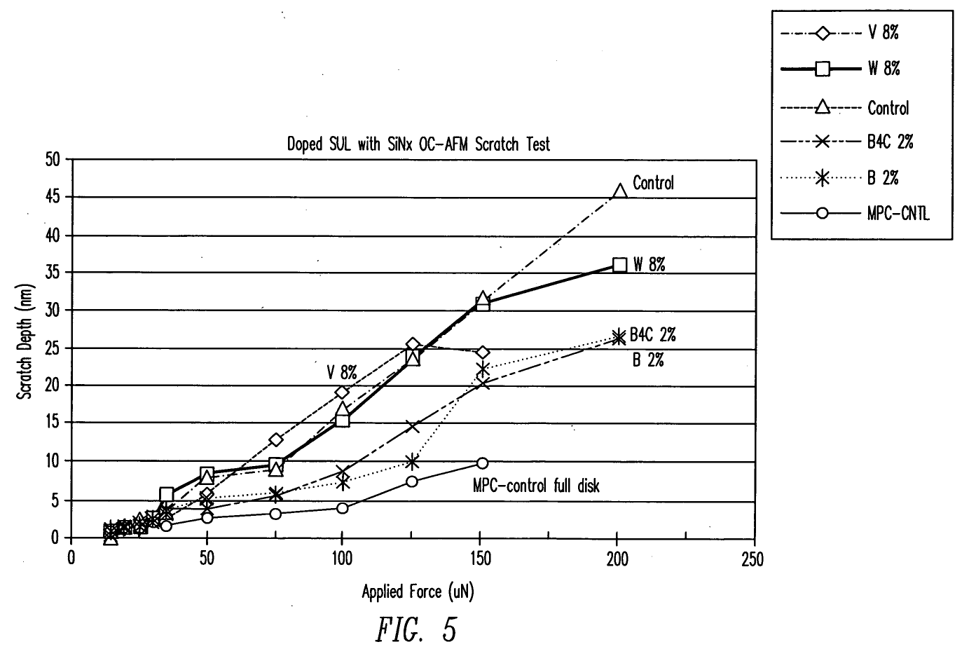

As the SUL is 92% Co, the glass transition temperature is dominated by Co (Tₘ=1495 C). FIGS. 4-6 describe results of an SUL with one the following additives W (Tₘ=3410 C), Nb (Tₘ=2468 C), B (Tₘ=2300 C), B₄C (Tₘ=2450 C) and V (Tₘ=1890 C). Doping of these materials was performed by co-sputtering the CoTaZr with elemental targets of W, V, Nb, B and B₄C. The dopant amount ranged from 0-12% and the B and B₄C were RF sputtered. For the dopant to be effective in modifying the alloy Tg, it should have a higher melting point than the alloy constituents. However, this is not sufficient, it should also be incorporated in the local atomic environment of the material at the effective growth temperature. Therefore, the most effective dopant for incrementing the mechanical hardness of the SUL is determined by the effective growth temperature of the recording medium.

FIG. 4 shows the effect of the dopants on the magnetic properties of the SUL. In FIG. 4, the saturation magnetization is plotted versus the dopant level. The figure shows that all the dopants lead to a reduction of the magnetic moment. However, the degree of reduction varies markedly when comparing the various dopants. B₄C and B are observed to reduce the moment by 38% when the dopant level reaches 8%, whereas V, Nb and W decrease by 9%, 14% and 21% respectively for the same dopant level.

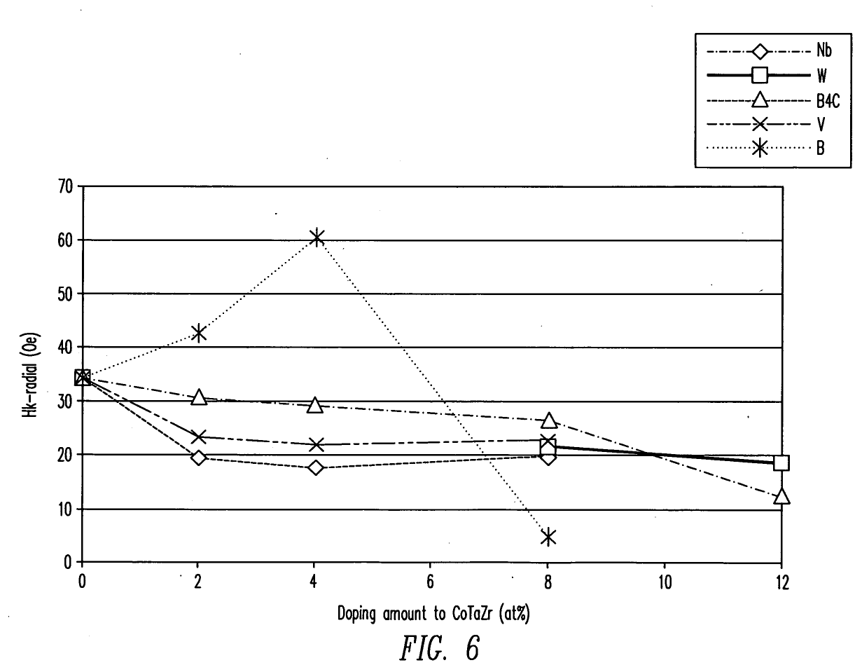

FIG. 5 shows the effect of the SUL doping on mechanical hardness by examining nanoindentation of the samples. Specifically, the nanoindentation was quantified by examining scratch depth by AFM. FIG. 5 compares measurements of AFM scratch depth vs nanoindenter applied force for SULs doped with W, V, B₄C and B. The results are compared to an undoped sample made in the same run and to a full longitudinal recording media structure (MPC) comprising only crystalline layers. The MPC sample is expected to be the hardest of the samples tested as it comprises no amorphous layers.

FIG. 5 demonstrates that adding about 2 atomic % of B₄C or B to the 60 nm CoTaZr soft underlayers, decreased the AFM scratch depth significantly compared to that of the control (no dopant) and approached that of the finished longitudinal media (MPC). This is a direct consequence of the improved hardness brought about by the doping. In contrast doping with V and W with even higher dopant levels does not result in hardness improvements. This is because a high melting point alone is insufficient to improve mechanical hardness. As seen in FIG. 5, the effect of doping with highest melting point element, W (Tₘ=3410 C), and with the lowest V, (Tₘ=1890 C), are ineffective in improving the SUL mechanical hardness. Therefore, preferably, the dopant material is a non-metal that is readily intercalated within the amorphous structure local order in order to improve the mechanical properties. Boron in particular, is a small atom that can easily reside within nearest neighbor atomic sites. This explains also its strong effect in quenching of the SUL magnetic moment. The results indicate that B₄C is also readily incorporated, and as seen in FIGS. 4 and 5, has comparable effects on magnetic and hardness properties of the SUL. Doping with these materials at the 2% level results in a moment reduction of 14% which can easily be compensated by increasing the SUL thickness to maintain the desired permeability. These results are for sputtering near 70-90° C. However, at higher sputtering temperatures, it is likely that a high Tₘ material such as W will yield a more mechanically robust SUL. W can be expected to mix well at growth temperatures>250 C. However, different SUL alloy compositions must be employed if the amorphicity of the alloy is to be retained.

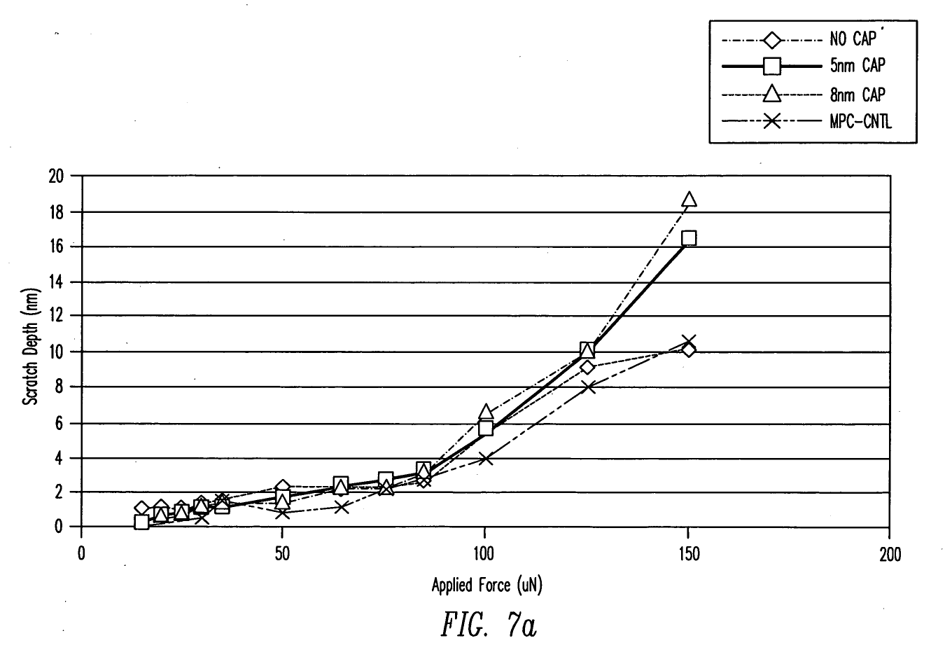

FIG. 6 shows dopant effect on radial magnetic anisotropy of CoTaZr soft underlayers. Boron is beneficial in incrementing the radial anisotropy of the SUL for doping amounts up to 4%. Said anisotropy increment is beneficial for the SUL domain stability and is expected to improve recording performance by decreasing the SUL noise contributions. B₄C has only a modest reduction in the radial anisotropy when compared to Nb, V and W.

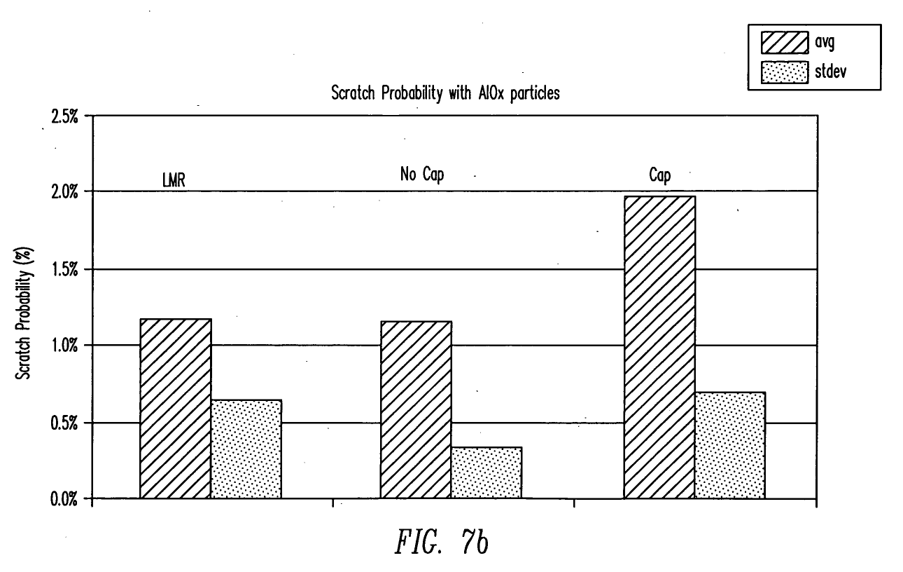

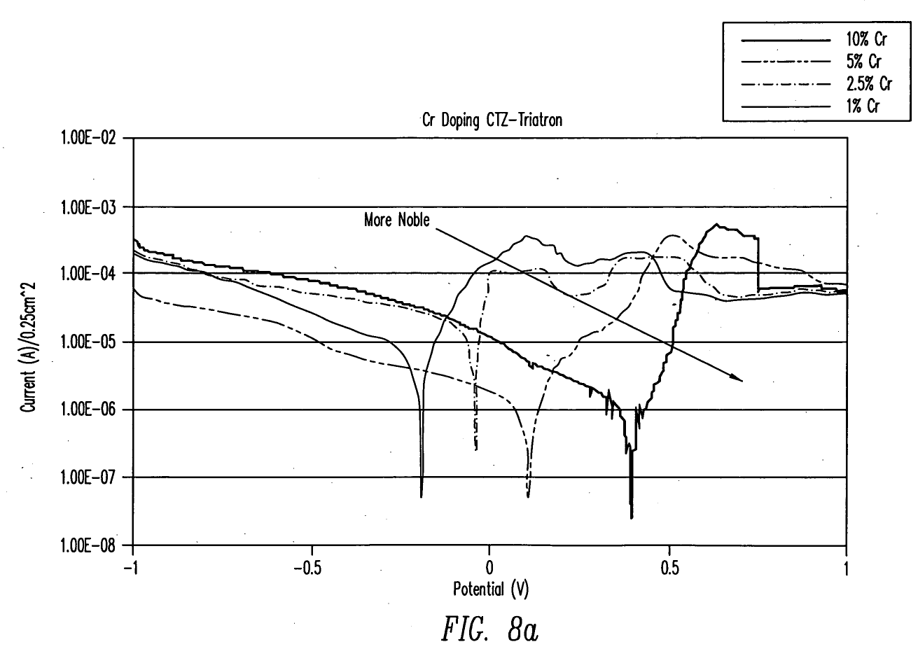

There is also a correlation between shallower AFM scratch depths obtained in nano-indentation studies and particle scratch robustness. To illustrate this point, a separate experiment in which nano-indentations studies were conducted in various structures. As seen in FIG. 7a, PMR a no cap disk has less scratch depth at 150 uN than the 5 nm cap disk and therefore it can be expected to be more robust. The corresponding results for particle scratch robustness is given in FIG. 7b in which it is clearly seen that the particle induced scratch probability of PMR no cap disk is less than that of 5 nm cap disk. Therefore, it can be expected by those skilled in the art, that doping of the SUL with judiciously chosen elements and alloy materials will result also in particle scratch resistance improvements which is desirable for file reliability. B, B₄C, BN and SiC are examples of such elements and alloys.

Transition Metals in the SUL

The corrosion resistance of the amorphous soft underlayer is improved by incorporating one or more judiciously chosen transition metal elements within the alloy composition. The improvement is brought about by specific transition elements and that the choice of the correct dopant increases the uniaxial anisotropy of the soft underlayer which is highly desirable for SUL noise suppression.

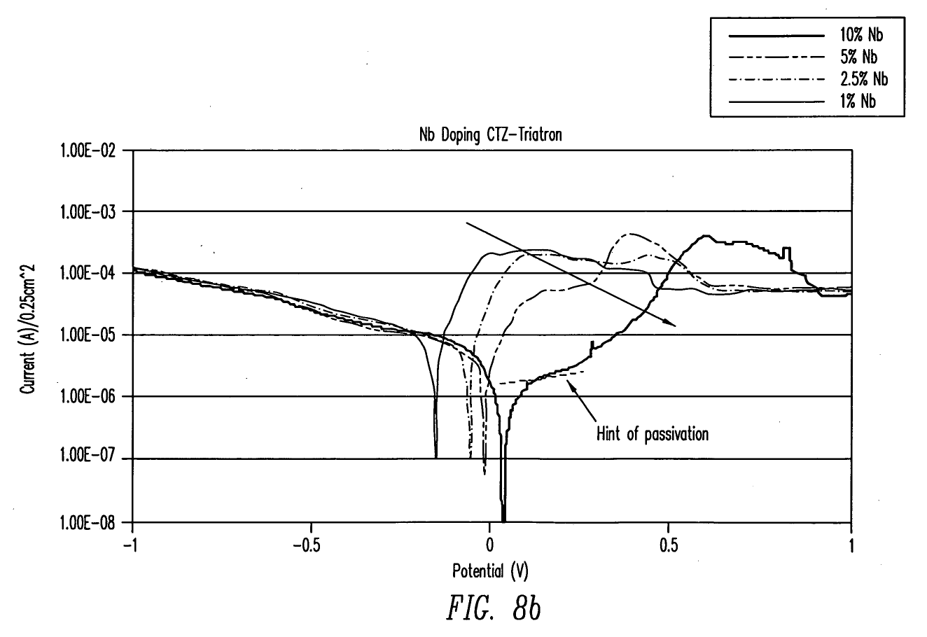

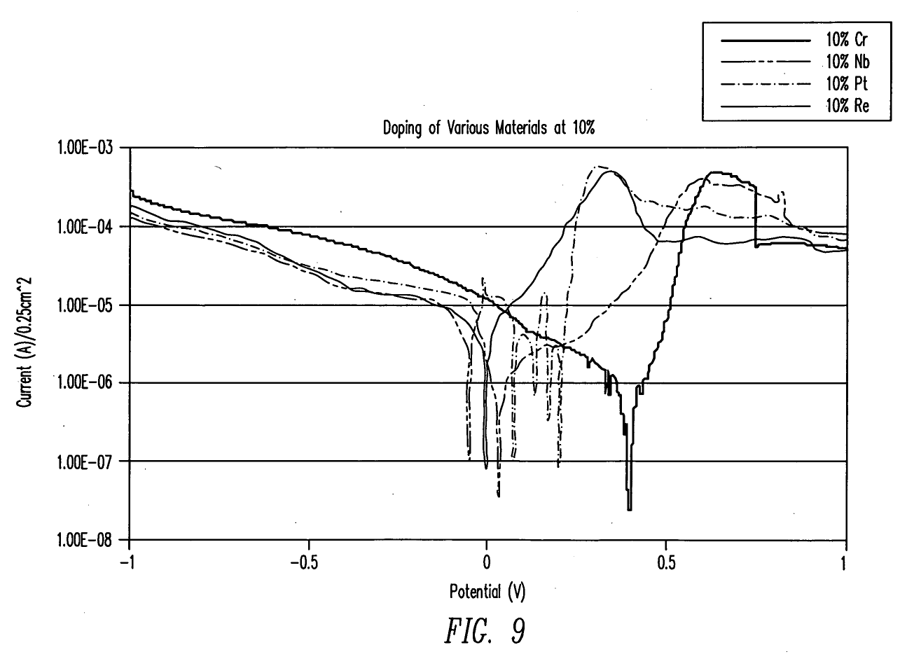

FIGS. 8-9 show test on test sample structures. The samples include 60 nm thick films of CoTaZr deposited on textured glass substrates overcoated with 3 nm thick AlTi layers. Doping was accomplished by co-sputtering the CoTaZr with the following transition elements: Cr, Pt, Re, Nb, Ti and Ta. The dopant amount ranged from 0-10%. Two sample series were prepared, one without a protective overcoat and another set overcoated with 2.5 nm of SiN. More than one dopant may be used to dope the SUL.

Transition metal additions to amorphous thin films can improve their inherent corrosion characteristics by two mechanisms. First, the dopant can modify the chemical potential of the alloy. Second the dopant can lead to changes in the density and surface energy of the amorphous thin film. The latter can be expected to improve the adhesion and coverage of films subsequently grown on these doped SUL materials.

The corrosion characteristics of the samples were evaluated through polarization current measurements. In the measurements, the potential is swept between the sample surface and a noble counter electrode and the exchange current is monitored with DI water as the electrolyte. The anodic current density is a good measure of the corrosion propensity of an alloy and higher currents are indicative of higher corrosion propensity. The measurements permit quantitative assessment of the unovercoated thin film nobility as well as its passivation characteristics. Similarly, for the overcoated specimens, improvements on Eoc (open circuit potential) are indicative of improved overlayer coverage and smoothness.

FIGS. 8a and 8b compare the effect of increasing doping amounts of Cr and Nb into the CoTaZr soft underlayer. Unovercoated 60 nm thick samples were employed for these measurements. The figure indicates that as the transition metal doping amount is incremented, the alloy becomes more noble. However, the shape of the corrosion current curves for the case of the Cr-doped materials indicate that these films, do not develop passivation characteristics. In contrast, one sees that Nb-doping first of all, leads to a reduction in corrosion current of approximately 100 times up to 200 mV above the open circuit potential. In addition, the polarization curve for 10% doped Nb showed clear onset of passivation as evidenced by the decrease in the slope of the anodic branch. Passivation, the spontaneous formation of a corrosion barrier layer, is a goal of corrosion improvement of any alloy as this behavior leads to long term corrosion resistance. This is evident for both the 5% and 10% doped Nb—CoTaZr SULs.

FIG. 9 shows the effect of doping CoTaZr with Cr, Nb, Pt and Re at a 10% level. The largest increment in nobility improvement is due to Cr doping and the least by Pt. However, as indicated above, Cr-doping may not lead to thin film passivation. The results of FIGS. 8a, 8b and 9 indicate that Nb doping improves the inherent corrosion resistance of the SUL. Similar polarization current measurements were conducted in transition metal-doped CoTaZr SULs in SiN overcoated SUL films.

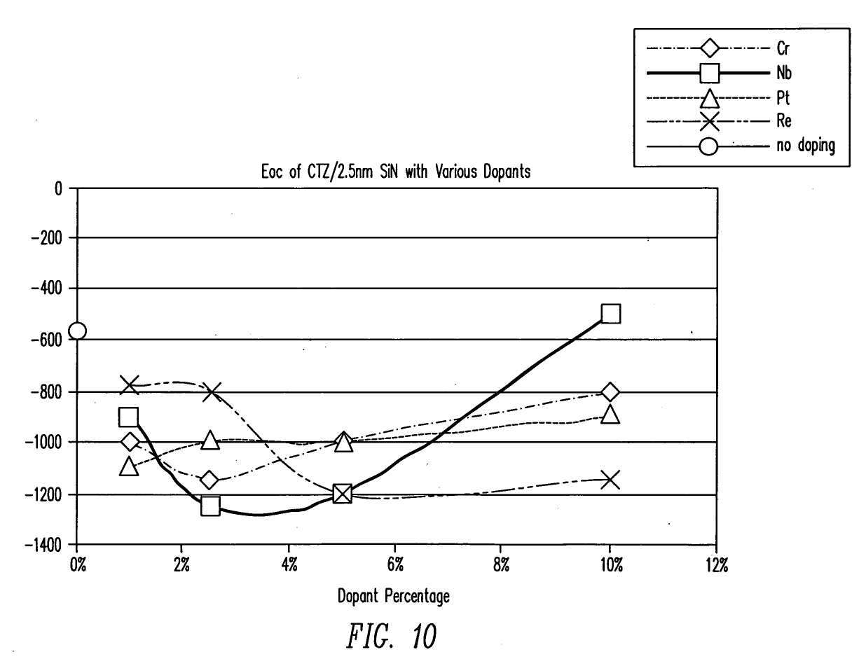

FIG. 10 is a graph of open circuit potentials vs dopant concentration in CoTaZr SULs. The figure illustrates the corrosion improvements brought about by Nb, Cr, Pt and Re doping. Nb doping shows improvement, even for dopant levels of less than 3%. Similar benefits are observed for Re doping at amounts of greater than 5%. The effect of Cr is similar but less beneficial than that of Nb doping.

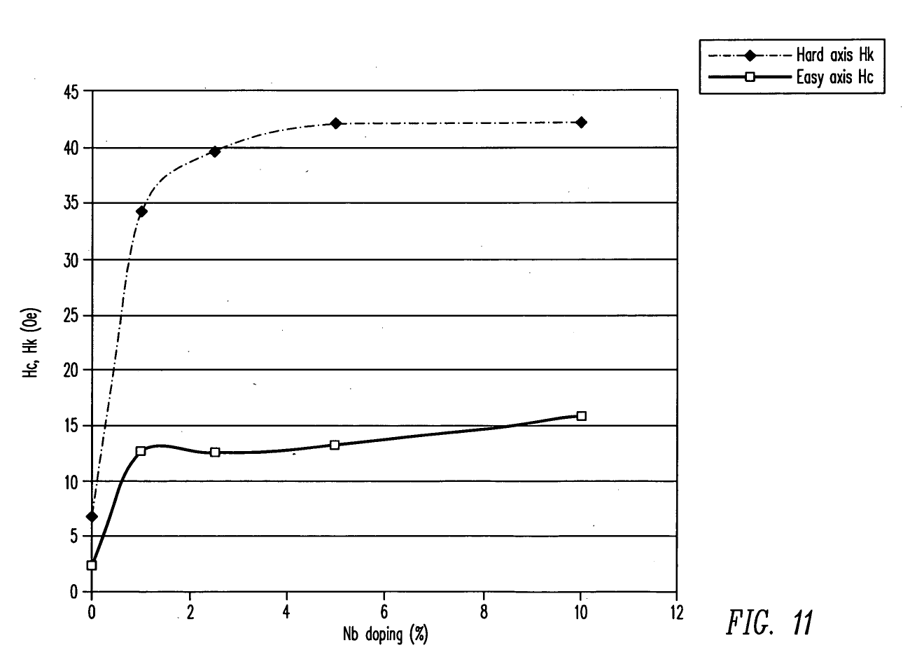

FIG. 11 is a graph of the effect of Nb doping into CoTaZr soft underlayers on coercivity and uniaxial anisotropy. The graph shows that the magnetic anisotropy of the SUL is increased by Nb doping and that the radial coercivity is modestly incremented. Therefore Nb doping of CoTaZr soft underlayers improves corrosion resistance and magnetic properties of the amorphous alloys.

Transition Metals Nanolayers

Nano-layer thick spacers and capping layers between 0.5 and 4.0 nm also provide corrosion resistance to soft underlayers.

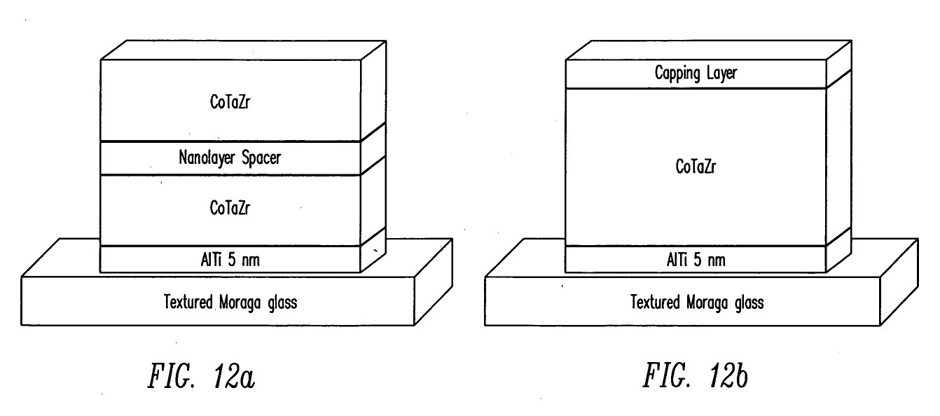

FIG. 12 shows soft underlayer structures for improving corrosion characteristics of PRM. FIG. 12(a) employs nm-thick spacers within one layer of an SUL or an AFC-SUL. FIG. 12(b) is a nanolayer capping layer on top of the SUL or AFC-SUL structure and prior to deposition of the OL or IL films.

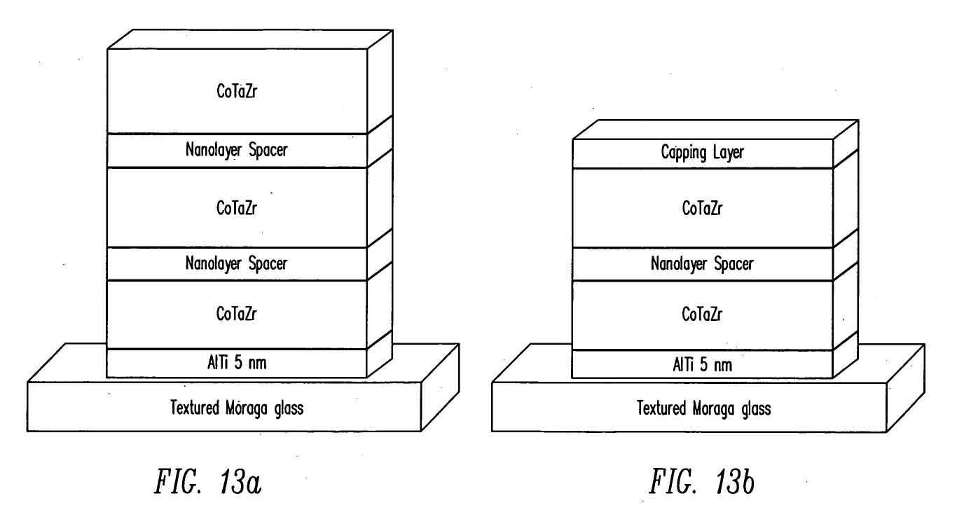

Although the use of a single nanolayer is depicted in FIGS. 12(a) and 12(b), a plurality of nanolayers could be employed. It is also recognized that additional improvements afforded by the invention can be derived by combining the architectures of both configurations depicted in FIG. 13a and FIG. 13(b). The drawings are meant to be illustrative and not restrictive, for example a combination of the multilayer stack combined with a capping layer could offer optimum corrosion protection. Furthermore, the placing of nanolayers is not limited to the number of layers and spacers illustrated in the figures.

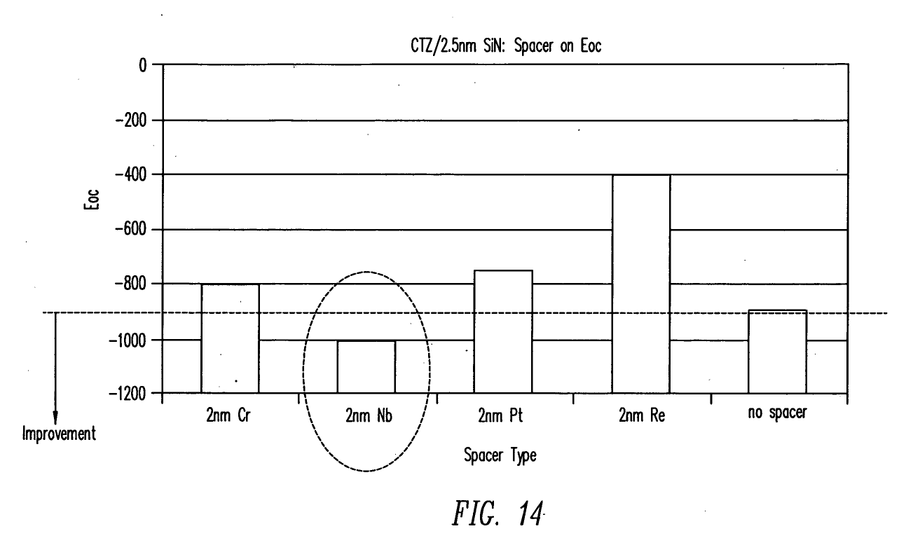

FIG. 14-16 are results from a series of 60 nm thick CoTaZr samples grown on AlTi coated glass substrates and then overcoated with 2.5 nm thick layers of SiN.

The thin film structures of FIGS. 14-16 comprising the nanolayer spacer were grown employing three sputter stations: a 30 nm thick layer of CoTaZr was first deposited on the AlTi-coated glass using a high moment cathode. Next a nanolayer spacer (2 nm thick) was deposited on the adjacent sputter station and finally 30 nm of CoTaZr were added on another station equipped with a high moment cathode prior to deposition of the overcoat.

The capped layer structures of FIGS. 14-16 were grown in two steps: first a 60 nm thick SUL layer was grown on the AlTi-coated glass upon which a 2 nm thick capping layer was deposited prior to the SiN overcoat.

Corrosion properties were evaluated through polarization current measurements and the results were compared to those obtained in single 60 nm thick layers of CoTaZr overcoated with 2.5 nm of SiN. For the case of the SUL with nanolayer spacers, comparison was made to a CoTaZr layer grown in two 30 nm deposition steps, employing different sputtering stations of the deposition tool equipment.

FIG. 14 compares the corrosion characteristics of SUL layers comprising 2 nm thick spacer layers of Cr, Nb, Pt and Re. It is a graph of open circuit potential measurements for SUL structures comprising nanolayer spacers of various transition metals. The negative value of Eoc is indicative of SUL corrosion resistance. The reference sample in FIG. 14 is labeled “no spacer” and as described above, it was deposited in two steps each providing 30 nm thick SUL sublayers. Comparison of Eoc values for the different spacers employed indicates that the Nb spacer provides a high degree of corrosion protection for an SiN overcoated SUL.

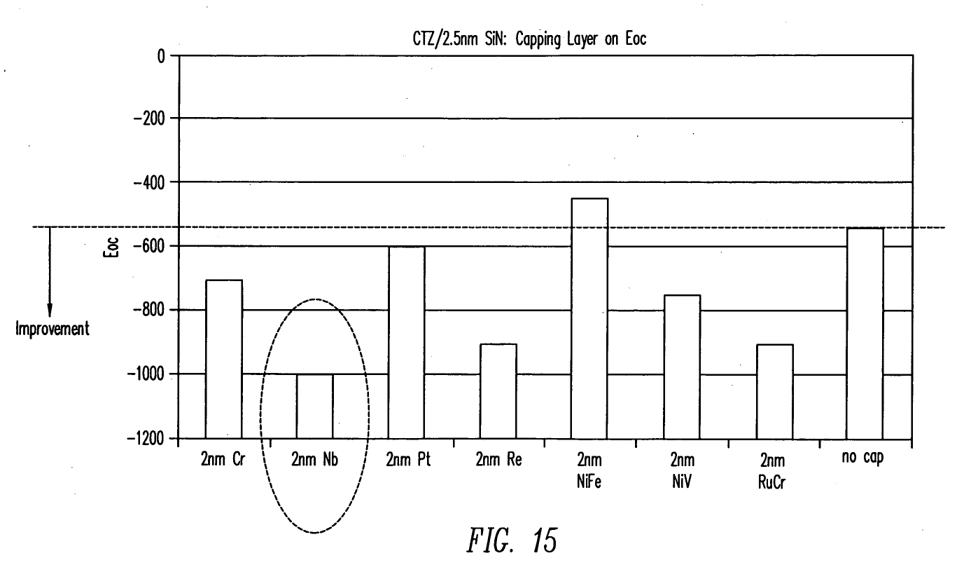

In FIG. 15, the corrosion protection afforded by employing ultrathin capping layers as taught by the invention is provided. FIG. 15 is a graph of open circuit potential measurements for SUL structures capped with various 2 nm thick layers of various transition metals and binary alloys. The reference sample (no cap) was grown in the same sputtering station as the capped SUL structures. The figure shows that the reference layer exhibits the worse corrosion characteristics. FIG. 15 shows Nb provides the largest improvement and is almost a factor of 2× better than the reference sample. Re and RuCr25 also exhibit significant protection characteristics.

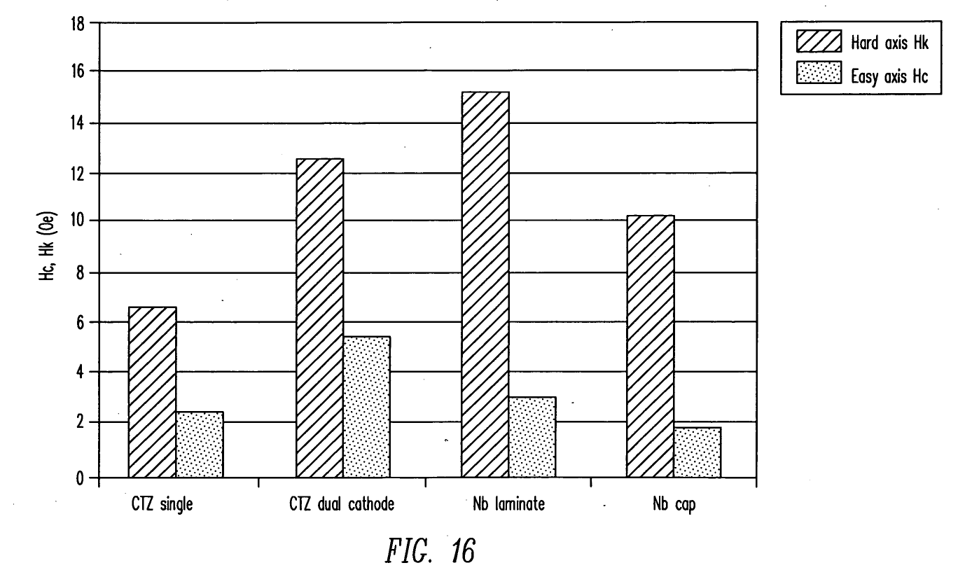

FIG. 16 is a graph where the easy axis coercivity and the uniaxial anisotropy are compared between SULs employing nanolayers and those measured in identical layers employing either single or dual layer deposition. Comparison of the anisotropy field, indicates that employing a nanolayer of Nb enhances the uniaxial anisotropy. An Nb cap increase Hk which is beneficial for improving SUL recording noise characteristics. Further, Hk increments are attained without significant changes in easy axis coercivity of the SUL. This is beneficial for high data rate applications of perpendicular media.

The amorphous alloys in the SUL, transition metals in the SUL and transition metals nanolayers can be used in conjunction (two at a time or all three) to further enhance the performance of an SUL.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A perpendicular magnetic recording medium comprising:
a substrate;
a soft underlayer including at least three elements above the substrate;
a perpendicular magnetic recording layer above the soft underlayer comprising Co or Fe; and
wherein the soft underlayer (SUL) includes an additional non-metal element or alloy with a Tm>1890 C.

2. The perpendicular recording medium of claim 1, wherein the additional element is at least one of B, B₄C, BN and SiC.

3. The perpendicular recording medium of claim 2, wherein the additional element amount ranges from 0 to 12%

4. The perpendicular recording medium of claim 2, wherein the soft underlayer includes and amorphous alloy including CoTaZr.

5. The perpendicular recording medium of claim 2, wherein the SUL structure is a single layer.

6. The perpendicular recording medium of claim 2, the SUL structure is an AFC dual layer structure.

7. The perpendicular recording medium of claim 1, wherein the additional element includes B.

8. The perpendicular recording medium of claim 7, wherein the additional element amount in the SUL ranges from 0 to 12 at %.

9. The perpendicular recording medium of claim 7, wherein the additional element amount ranges in the SUL from 0 to 6 at %.

10. The perpendicular recording medium of claim 7, wherein the additional element amount ranges in the SUL from 0.5 to 3 at %.

11. The perpendicular recording medium of claim 1, wherein the additional element includes W.

12. A perpendicular magnetic recording medium comprising:
a substrate;
a soft underlayer including at least three elements above the substrate;
a perpendicular magnetic recording layer above the soft underlayer; and
wherein the soft underlayer (SUL) is includes at least one additional element of Cr, Pt, Re, Nb and Ti in an amount of less than 6 at. %.

13. The perpendicular magnetic recording medium of claim 12, wherein the additional element is at least one of Nb, Re and Cr.

14. The perpendicular magnetic recording medium of claim 13, wherein the additional element concentration in the SUL is between 0-15 at %.

15. The perpendicular magnetic recording medium of claim 13, wherein the additional element concentration in the SUL is between 0.5 to 5 at %.

16. The perpendicular magnetic recoding medium of claim 12, wherein the additional element addition does not reduce the alloy magnetic moment by more than 20%.

17. The perpendicular magnetic recoding medium of claim 12, where the additional element increases the nobility of the SUL alloy and exhibits self-passivation.

18. The perpendicular magnetic recoding medium of claim 12, wherein the additional element increases the uniaxial magnetic anisotropy of the SUL.

19. The perpendicular magnetic recoding medium of claim 13, wherein the SUL comprises CoTaZr.

20. The perpendicular magnetic recoding medium of claim 13, wherein the concentrations in the SUL include Co between 70-97 at. %, Ta between 0-30 at. %, and Zr between 0-30 at. %.

21. The perpendicular magnetic recoding medium of claim 12, wherein the additional element is Nb and the concentration of Nb is between 0.5-10 at. %.

22. The perpendicular magnetic recoding medium of claim 12, wherein the additional element is at least one of Pt, Re and Cr and the concentration of the additional element is between 0.5-10 at. %.

23. A perpendicular magnetic recording medium comprising:
a substrate;
a soft underlayer above the substrate;
a perpendicular magnetic recording layer above the soft underlayer; and
wherein the soft underlayer (SUL) is at least one of capped with a 0.5 to 4.0 nm metal or metal alloy layer and intercalated by a 0.5 to 4.0 nm metal or metal alloy layer.

24. The perpendicular magnetic recording medium of claim 23, wherein the SUL is capped 0.5 to 4.0 nm metal or metal alloy layer.

25. The perpendicular magnetic recording medium of claim 23, wherein the SUL is intercalated by 0.5 to 4.0 nm metal or metal alloy layer.

26. The perpendicular magnetic recording medium of claim 24, wherein the SUL is intercalated by a 0.5 to 4.0 nm metal or metal alloy layer.

27. The perpendicular magnetic recording medium of claim 23, wherein the SUL is intercalated by a plurality of 0.5 to 4.0 nm metal or metal alloy layers.

28. The perpendicular magnetic recording medium of claim 24, wherein the SUL is intercalated by a plurality of 0.5 to 4.0 nm metal or metal alloy layers.

29. The perpendicular magnetic recording medium of claim 23, wherein the metal or metal alloy layer includes Nb.

30. The perpendicular magnetic recording medium of claim 23, wherein the metal or metal alloy layer include at least one of Nb, Re, Cr or Pt.

31. A perpendicular magnetic recording medium comprising:
a substrate;
a soft underlayer including at least three elements above the substrate;
a perpendicular magnetic recording layer above the soft underlayer comprising Co or Fe; and
wherein the soft underlayer (SUL) includes an first additional non-metal element or alloy with a Tm>1890 C and a second additional element of Cr, Pt, Re, Nb and Ti in an amount of less than 6 at. %; and
the soft underlayer (SUL) is at least one of capped with a 0.5 to 4.0 nm metal or metal alloy layer and intercalated by a 0.5 to 4.0 nm metal or metal alloy layer.
